(19) United States
(12) Patent Application Publication
(10) Pub. No.: US 2007/0223468 A1
(43) Pub. Date: Sep. 27, 2007

(54) Cell switch and readout method

(75) Inventor: Hideki Nishizaki, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC CORPORATION, Tokyo (JP)

(21) Appl. No.: 11/727,271

(22) Filed: Mar. 26, 2007

(30) Foreign Application Priority Data
Mar. 27, 2006 (JP) JP2006-086709

(51) Int. Cl. H04L 12/50

(52) U.S. Cl. 370/386; 370/412; 370/392

(57) ABSTRACT

The present invention provides a switching technology in which a complicated scheduler for all input/output ports as required in an input-buffer type switch is eliminated, a raise in the internal processing speed associated with an increased number of accommodated ports as involved in an output-buffer type switch or a shared-buffer type switch is avoided, and a significant increase of the size of hardware is avoided. According to the present invention, buffers are provided for all paths from all input ports to all output ports for allowing a fixed-length cell, which is a unit of a switching operation, to be written into a buffer separately for each path. Moreover, a readout control section is provided for each destination output port (for all input ports having the same destination) for managing the sequence of arrival of fixed-length cells at a buffer, and designation of a buffer from which a fixed-length cell is to be read (designation of an input port number) is made based on the sequence of arrival of fixed-length cells managed by each readout control section itself.

### BACKGROUND OF THE INVENTION

The present invention relates to a switching scheme for fixed-length cells including those converted from variable-length packets, and more particularly to a switch configuring method with low delay, high speed and large capacity.

General switch configurations include an input-buffer type switch, an output-buffer type switch, and a shared-buffer type switch.

FIG. 9 is a block diagram depicting the configuration of an input-buffer type switch. An input-buffer type switch is provided with buffers respectively for input ports for accumulating fixed-length cells in order to wait for those having the same destination port input via a plurality of the input ports. In this switch configuration, a second fixed-length cell or later in a buffer for an input port cannot be output until a first one at the top of the buffer is output; thus, if a fixed-length cell stored at the top of a buffer is made to wait because of contention of a destination output port with a fixed-length cell in another input port, the second fixed-length cell cannot be output in a condition called HOL blocking (Head Of Line blocking) even if no contention occurs with a destination port for the second fixed-length cell, resulting in a drawback that throughput is reduced.

To address this problem, there has been proposed the form of an input-buffer type switch as shown in FIG. 10, in which each input port is provided with buffers corresponding to destination output ports (VOQ: Virtual Output Queue). However, since the switch of this type requires scheduling for all paths (total number of input ports×total number of output ports) for determining a fixed-length cell from which input port is to be transferred to which output port, computational complexity is increased (requiring a larger size of hardware), resulting in a drawback that accommodation of multiple ports makes it difficult to implement such a configuration.

FIG. 11 is a block diagram depicting the configuration of an output-buffer type switch. The output-buffer type switch processes fixed-length cells input via all input ports in a multiplex manner, and the cells are each output to an output port as a signal at a speed N times the input port speed (N: the number of accommodated ports). Each output port is provided with a buffer for accumulating fixed-length cells for waiting when delivery of fixed-length cells by a plurality of input ports is concentrated at a time. In this switch configuration, a processing speed N times the interface speed (N: the number of input ports) is required for the internal processing speed of the switch, resulting in a drawback that the raise in the port speed and accommodation of multiple ports make it difficult to implement such a configuration.

FIG. 12 is a block diagram depicting the configuration of a shared-buffer type switch. The shared-buffer type switch is provided with a buffer between input and output ports commonly used by all the ports. Fixed-length cells input via all input ports are processed in a multiplex manner, are written into the buffer as a signal at a speed N times the input port speed (N: the number of input ports), and are read for being output to the output ports at the same speed as the write speed. In this switch configuration, a processing speed N times the interface speed (N: the number of input ports) is required for the internal processing speed of the switch, resulting in a drawback that the raise in the port speed and accommodation of multiple ports make it difficult to implement such a configuration.

There has been proposed a technology for a switch configuration as shown in FIG. 13, which eliminates scheduler processing for all input/output ports in an input-buffer type switch, and avoids a raise in the internal processing speed associated with an increased number of accommodated ports in an output-buffer type switch or shared-buffer type switch (see Patent Document 1, for example).

In that invention, a filter is provided for each output port for selectively passing only a fixed-length cell destined for the output port at which filter is disposed among fixed-length cells from all input ports. After passing through the filter, a fixed-length cell is subjected to switching processing so that fixed-length cells can be stored sequentially in N buffers disposed subsequent to an N×N switch (N: the number of input ports). The fixed-length cells stored in the N buffers are sequentially read on a cell-by-cell basis in the same sequence as that when they were written.

[Patent Document 1] Japanese Patent Application Laid Open No. H9-238144

### SUMMARY OF THE INVENTION

In the conventional switch configurations as described above, the input-buffer type switch has a problem of complexity of scheduler processing for all input/output ports, and the output-buffer type switch and shared-buffer type switch have a problem of a raise in the internal processing speed.

Although the switch configuration addressing these problems is the invention disclosed in Patent Document 1 as shown in FIG. 13 as described above, a raise in the port speed and accommodation of multiple ports are accompanied with a problem that the size of the circuit hardware of the N×N switch (N: the number of input ports) is significantly increased.

FIG. 14 shows a basic configuration of an N×N switch (N: the number of input ports). The switch is comprised of M (M: the number of output ports) blocks of N-to-one selectors for selectively outputting one of N input lines. While shown is the basic configuration having a single signal line for each input, since a raise in the input port speed requires an input signal under processing to be split in parallel into a plurality of low-speed signal lines due to limitation of the processing speed of the processing device, a number, which is equal to the parallel splitting, of the basic configurations of FIG. 11 are required. For example, an input signal should be split in parallel into 128 lines when the input signal speed of the switch is 10 Gbps and the internal processing speed of the device is 78.125 MHz, and 128 basic configurations of FIG. 14 are required, resulting in an increase of the size of hardware.

It is therefore an object to be attained by the present invention is to solve the aforementioned problems, that is, to provide a switch configuration in which a complicated scheduler for all input/output ports as required in an input-buffer type switch is eliminated, a raise in the internal processing speed associated with an increased number of accommodated ports as involved in an output-buffer type switch or a shared-buffer type switch is avoided, and a significant increase of the size of hardware associated with a raise in the port speed and accommodation of multiple ports as in the invention described in Patent Document 1 is avoided.

A first invention for solving the aforementioned problems is a cell switch having N input ports and M output ports, characterized in comprising:

filters for distributing cells input via said input ports and cell information indicating whether each cell is valid or not, among destination output ports;

cell buffers provided for each of said output ports, for holding a valid one among fixed-length cells managed for each of said input ports in the sequence of inputting; and

a readout controller for reading cells from said buffers based on said cell information.

A second invention for solving the aforementioned problems is the first invention, characterized in that:

said readout controller includes:
cell information buffers provided for each of said output ports, for holding cell information managed for each of said input ports in the sequence of inputting; and
a deciding section for simultaneously reading cell information from said cell information buffers, and reading a cell kept in said cell buffer corresponding to identification information that uniquely identifies an input port whose cell information is valid.

A third invention for solving the aforementioned problems is the first invention, characterized in that:

said readout controller includes:
an appending section for appending, to said cell information, identification information that uniquely identifies an input port to which said cell information has been input;
a switching section for outputting cell information that is valid among those appended with said identification information, evenly to said cell information buffers; and
a deciding section for reading cell information from said cell information buffer, and reading a cell kept in said cell buffer corresponding to identification information appended to said cell information.

A fourth invention for solving the aforementioned problems is the third invention, characterized in that:

said deciding section simultaneously reads said cell information from said cell information buffers.

A fifth invention for solving the aforementioned problems is the third invention, characterized in that:

said deciding means sequentially reads said cell information from said cell information buffers.

A sixth invention for solving the aforementioned problems is a readout method for a cell switch having N input ports M output ports, characterized in comprising the steps of:

distributing cells input via said input ports and cell information indicating whether each cell is valid or not, among destination output ports; and

reading-out, based on said cell information, cells from cell buffers provided for each of said output ports, for keeping a valid one among fixed-length cells managed for each of said input ports in the sequence of inputting.

A seventh invention for solving the aforementioned problems is the sixth invention, characterized in that:

said reading-out step includes the steps of:
simultaneously reading cell information from cell information buffers provided for each of said output ports, for keeping cell information managed for each of said input ports in the sequence of inputting; and
reading a cell kept in said cell buffer corresponding to identification information that uniquely identifies an input port whose cell information read is valid.

An eighth invention for solving the aforementioned problems is the sixth invention, characterized in that:

said reading-out step includes the steps of:
appending, to said cell information, identification information that uniquely identifies an input port to which said cell information has been input;
outputting cell information that is valid among those appended with said identification information, evenly to said cell information buffers; and
reading-out cell information from said cell information buffer, and reading-out a cell kept in said cell buffer corresponding to identification information appended to said cell information.

A ninth invention for solving the aforementioned problems is the eighth invention, characterized in that:

said reading-out step simultaneously reads said cell information from said cell information buffers.

A tenth invention for solving the aforementioned problems is the eighth invention, characterized in that:

said reading-out step sequentially reads said cell information from said cell information buffers.

According to the present invention for attaining the aforementioned objects, buffers are provided for all paths from all input ports to all output ports for allowing a fixed-length cell to be written into a buffer separately for each path.

Moreover, a readout control section is provided for each destination output port (for all input ports having the same destination) for managing the sequence of arrival of fixed-length cells at a buffer for each destination output port, and designation of a buffer from which a fixed-length cell is to be read (designation of an input port number) is made based on the sequence of arrival of fixed-length cells managed by each readout control section itself.

According to the present invention, a fixed-length cell is written into one of buffers provided for all paths from all input ports to all output ports. Since the buffers are provided separately for all paths, blocking is prevented and writing is enabled without raising the processing speed due to multiplex processing etc. when multiple ports are accommodated. For a fixed-length cell to be written into a buffer, it is read, and output via an output port, such that the sequence of arrival of fixed-length cells at the buffer is managed at a readout control section for each destination output port (for all input ports having the same destination), and designation of the buffer from which a fixed-length cell is to be read (designation of an input port number) is made based on the sequence of arrival of fixed-length cells managed by each readout control section itself.

According to the present invention, since the buffers are provided separately for all paths and a schedule for reading fixed-length cells is separated for each output port, it is possible to eliminate a raise in the internal processing speed associated with a complicated scheduler for all input/output ports and an increased number of ports to be accommodated.

Moreover, since an N×N switch in the conventional technique, which may pose a problem that the size of a circuit is increased when accommodation of multiple ports and a raise in the port speed are contemplated, is eliminated, and the sequence of arrival of fixed-length cells is managed to decide a port from which a fixed-length cell is to be read based on parameters of smaller size of information such as cell arrival information and an input port number, instead of a fixed-length cell that may pose a problem that an increased number of parallel splitting is concerned when high-speed ports are to be accommodated, a significant increase of the size of hardware associated with a raise in the port speed and accommodation of multiple ports can be restrained.

### BRIEF DESCRIPTION OF THE DRAWINGS

This and other objects, features and advantages of the present invention will become more apparent upon a reading of the following detailed description and drawings, in which:

FIG. 1 is a block diagram of a first embodiment of the present invention;

FIG. 2 is a block diagram depicting the internal configuration of a readout control section;

FIGS. 3a and 3b are diagrams for explaining write processing for input-cell information into buffers 1-N in the readout control section;

FIGS. 4a and 4b are diagrams for explaining readout processing for input-cell information from buffers 1-N in the readout control section;

FIG. 5 is a block diagram of a second embodiment of the present invention;

FIG. 6 is a block diagram depicting the configuration of a readout control section in the second embodiment;

FIG. 7 is a diagram for explaining write processing for input-cell information into buffers 1-N in the readout control section;

FIG. 8a is a diagram for explaining readout processing for simultaneously reading input-cell information from buffers 1-N in the readout control section for all buffers in a cycle of four cells;

FIG. 8b is a diagram for explaining readout processing for sequentially reading input-cell information from buffers 1-N in the readout control section on buffer-by-buffer basis;

FIG. 9 is a block diagram of a conventional input-buffer type switch;

FIG. 10 is a block diagram of another conventional input-buffer type switch provided with buffers for each input port, the buffers respectively provided for destination output ports;

FIG. 11 is a block diagram of a conventional output-buffer type switch;

FIG. 12 is a block diagram of a conventional shared-buffer type switch;

FIG. 13 is a block diagram for explaining a conventional technique; and

FIG. 14 is a block diagram for explaining the basic configuration of an N×N switch.

### DESCRIPTION OF THE EMBODIMENTS

Now the configuration of the present invention will be described.

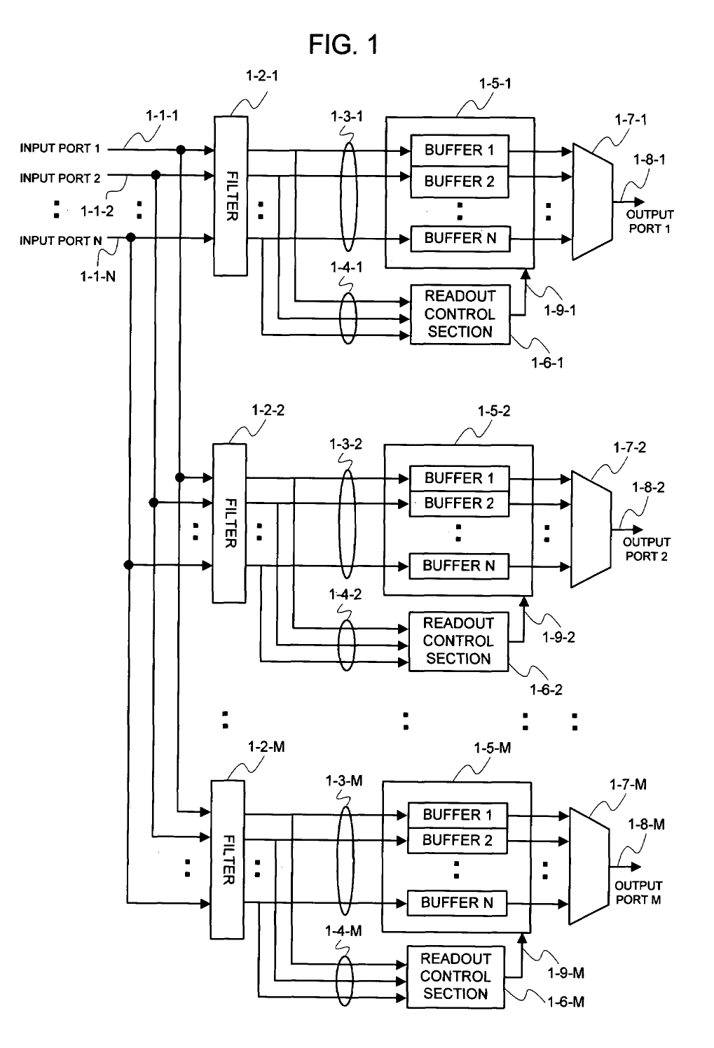

FIG. 1 is a block diagram depicting one embodiment of the present invention. FIG. 1 shows the configuration in which N (N: the number of input ports) input ports and M (M: the number of output ports) output ports are accommodated, where N represents the number of input ports (a positive integer) of the switch, and M represents the number of output ports (a positive integer) of the switch.

Input signals 1-1-1-1-1-N supplied via input ports 1-N each have a main signal (fixed-length cell) divided to have a fixed length at a preceding interface, and input-cell information (a signal indicating whether the current fixed-length cell is valid or not), configured as a set.

Filters 1-2-1-1-2-M are provided respectively for output ports. Each filter performs processing of passing only a valid one among fixed-length cells input via the input ports 1-N that is destined for the output port at which that filter is disposed, and invalidating other fixed-length cells, and the filter has its output connected to buffers 1-5-1-1-5-M and readout control sections 1-6-1-1-6-M.

The buffers 1-5-1-1-5-M are each comprised of N FIFO (First In First Out) memories corresponding to the input ports. A valid fixed-length cell passed through each of the filters 1-2-1-1-2-M is sequentially written into an FIFO memory for an input port in the buffers 1-5-1-1-5-M (only valid fixed-length cells are written). Readout of fixed-length cells from the buffers is controlled by the readout control sections 1-6-1-1-6-M, and the read fixed-length cells are output to selectors 1-7-1-1-7-M.

Each of the readout control sections 1-6-1-1-6-M is supplied with only a signal indicating whether a fixed-length cell is valid among the signals output by a filter. Input-cell information (signal indicating validity) for a fixed-length cell is managed in the sequence of arrival, and each readout control section 1-6-1-1-6-M gives a readout direction to each buffer 1-5-1-1-5-M such that fixed-length cells are read in the sequence of arrival. Since the readout control sections 1-6-1-1-6-M control readout such that buffers for a plurality of input ports are not simultaneously read, a plurality of valid fixed-length cells are not simultaneously output from the buffers 1-5-1-1-5-M.

The selector sections 1-8-1-1-8-M are each comprised of a selector having N inputs and one output, and connected with the N buffers in each buffer 1-5-1-1-5-M. The selector sections output fixed-length cells read by the readout control sections.

Next, the operation of the present embodiment shown in FIG. 1 will be described.

Input signals 1-1-1-1-1-N input via the input ports 1-N each have a fixed-length cell and input-cell information (a signal indicating whether the current fixed-length cell is valid or not), configured as a set. The input signals 1-1-1-1-1-N are connected to the filters 1-2-1-1-2-M in a multiplex connection manner.

The filters 1-2-1-1-2-M are provided respectively for output ports, and each pass only a fixed-length cell that is destined for the output port at which that filter is disposed, and invalidates other fixed-length cells. For example, the filter 1-2-1 identifies only a fixed-length cell destined for the output port 1 as a valid cell among the input signals 1-1-1-1-1-N, and those destined for the other output ports as invalid cells. This processing is achieved by invalidating input-cell information that serves as a counterpart of the current fixed-length cell in a set and that is transmitted along with the cell. It should be noted that this processing is similarly carried out in the filters 1-2-2-1-2-M.

Signals (each comprising a fixed-length cell and input-cell information) 1-3-1-1-3-M passing through the filters 1-2-1-1-2-M are input to the buffers 1-5-1-1-5-M.

The buffers 1-5-1-1-5-M are each comprised of N FIFO (First In First Out) memories of buffers 1-N that respectively correspond to input ports 1-N. Only valid fixed-length cells are written into N FIFO memories in the buffers 1-5-1-1-5-M.

Signals 1-4-1-1-4-M input to the readout control sections 1-6-1-1-6-M have only input-cell information (a signal indicating whether the current fixed-length cell is valid or not) output by the filters 1-2-1-1-2-M.

The readout control sections 1-6-1-1-6-M manage the signals 1-4-1-1-4-M indicating whether their respective fixed-length cells are valid or not in the sequence of the arrival time, and controls readout for N FIFO memories in the buffers 1-5-1-1-5-M such that fixed-length cells are read in the sequence of the arrival time.

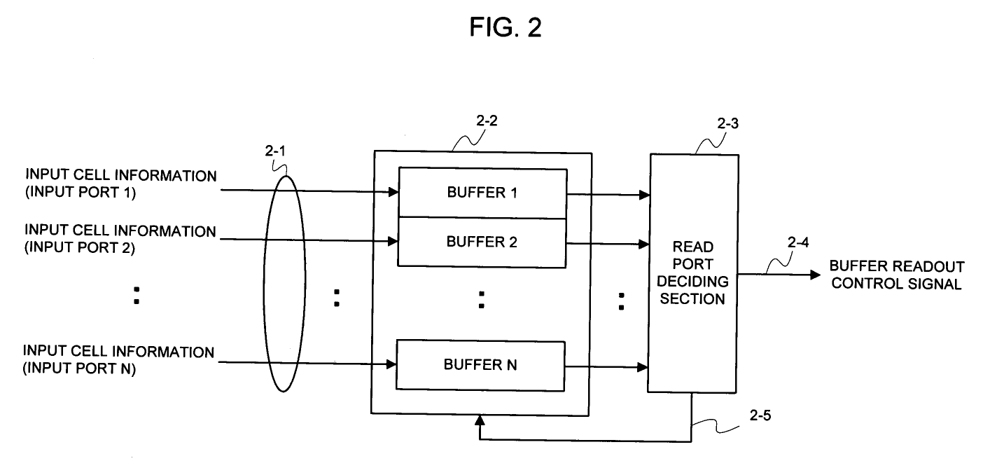

Next, the operation of the present embodiment shown in FIG. 2 will be described.

FIG. 2 is a block diagram depicting the internal configuration of each readout control section 1-6-1-1-6-M in FIG. 1.

Input-cell information 2-1 are input to a buffer 2-2.

The buffer 2-2 is comprised of N FIFO (First In First Out) memories of buffers 1-N respectively corresponding to input ports 1-N. Into the buffers 1-N, information in the input-cell information 2-1 are written in the sequence of arrival whether it is valid or not, except the case in which input-cell information that are simultaneously input all indicate invalid.

A read port deciding section 2-3 simultaneously reads information on a piece-by-piece basis from the buffers 1-N with reference to a buffer readout signal 2-5, and sends a buffer readout control signal 2-4 to allow data of the input port whose input-cell information indicates valid among those read from the buffers 1-N to be sequentially read.

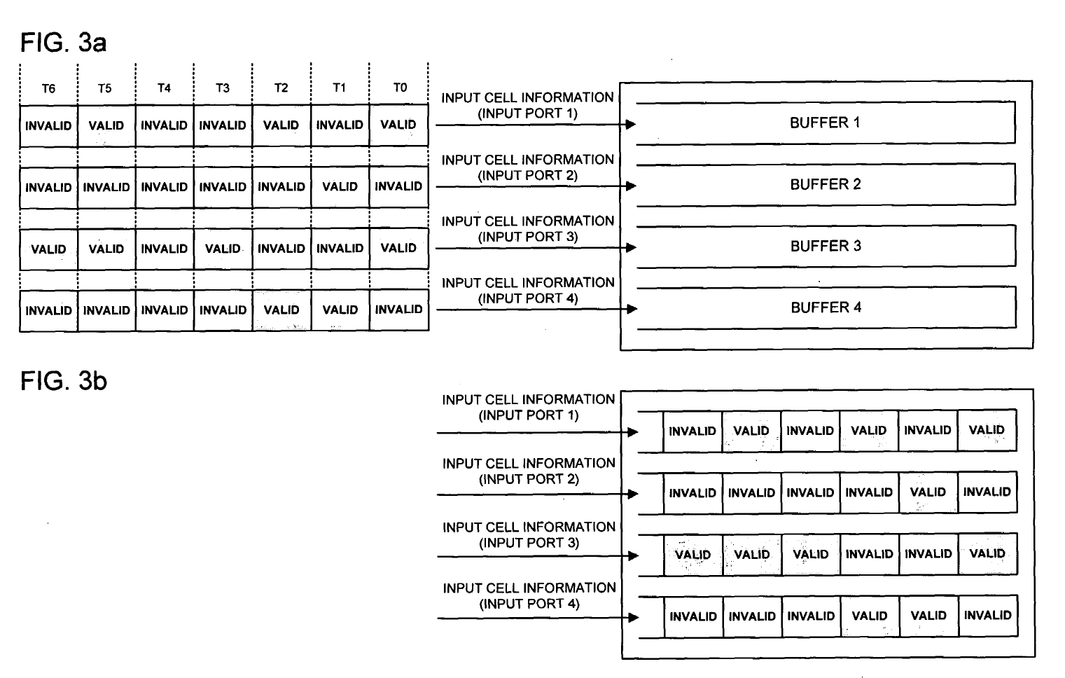

FIGS. 3a and 3b are block diagrams schematically showing write processing for input-cell information into the buffers 1-N in the readout control section of FIG. 2. In this drawing, the number of input ports N is assumed to be four.

As shown in FIG. 3a, input-cell information (a signal indicating an input fixed-length cell is valid or not) for a fixed-length cell being input is input in the sequence of time T0-->T1-->T2--> . . . -->T6. In this a case, input-cell information at a port 1 is written into a buffer 1, and similarly, input-cell information at ports 2-4 are written into buffers 2-4, respectively. At T4, since a fixed-length cell is invalid at all of the ports 1-4, it is not written into any buffer (FIG. 3b).

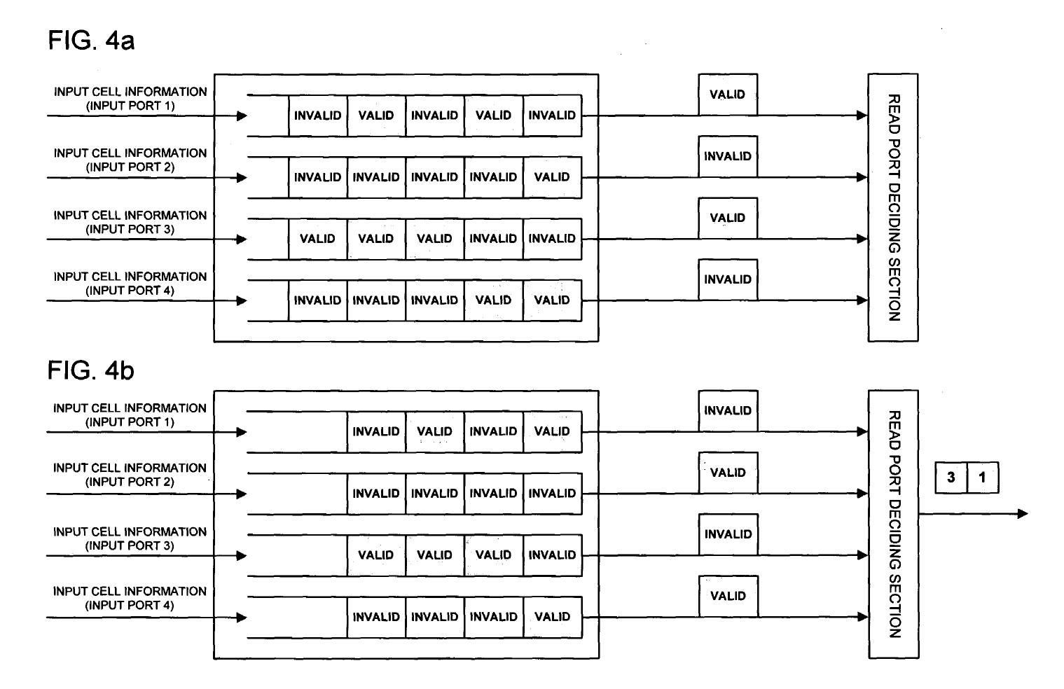

FIGS. 4a and 4b are block diagrams schematically showing readout processing for input-cell information from the buffers 1-N in the readout control section of FIG. 2. In this drawing, the number of input ports N is assumed to be four.

Input-cell information accumulated in the buffers as shown in FIG. 3b are read in the sequence of arrival. The read port deciding section reads information written at the top of each buffer, i.e., the information input at the time T0 in FIG. 3a (FIG. 4a). In these information, input-cell information at the input ports 1 and 3 indicate valid.

Based on such information, the read port deciding section 2-3 sends a buffer readout control signal 2-4 such that fixed-length cells at the input ports 1 and 3 are to be read, and reads next input-cell information from the buffers at the same time (FIG. 4b). Although the example of FIG. 4b shows a case in which control is made to read the input port 3 subsequent to the input port 1, it is possible to read the fixed-length cells that have simultaneously arrived in a flexibly varying sequence taking account of the fairness or priority among the ports.

Next, a second embodiment of the present invention will be described.

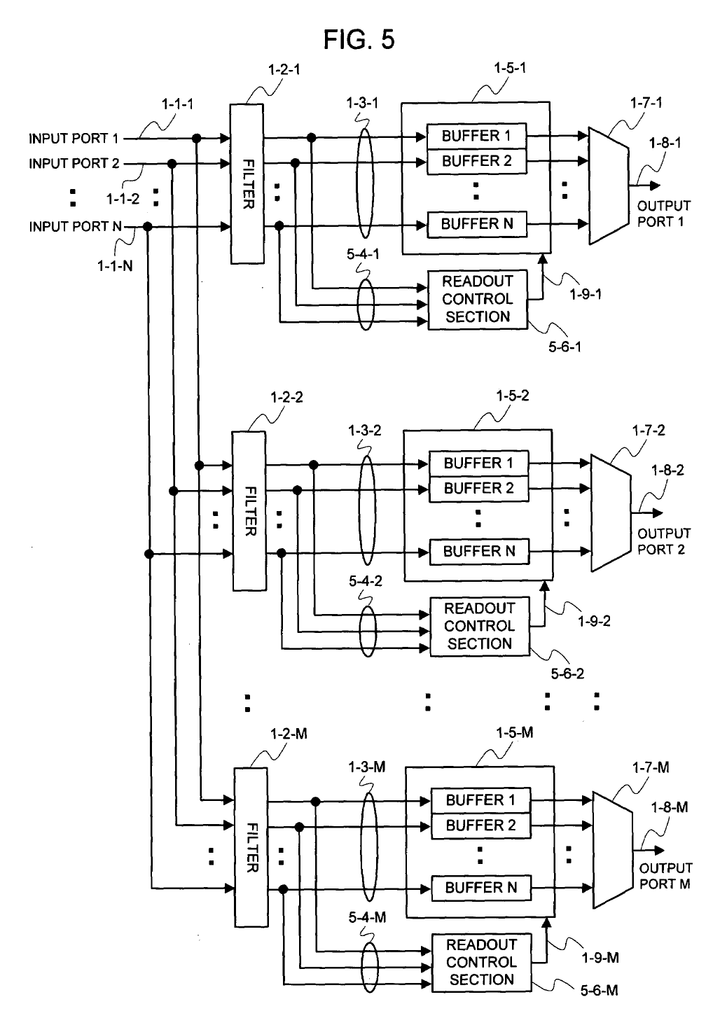

The overall configuration of the second embodiment of the present invention is shown in FIG. 5. This configuration per se is generally similar to that of the first embodiment shown in FIG. 1, except as the internal configuration of, and input signals to, the readout control sections 1-6-1-1-6-M in the first embodiment. In the drawing, similar components to those in the first embodiment are designated by the like numerals, and detailed description thereof will be omitted.

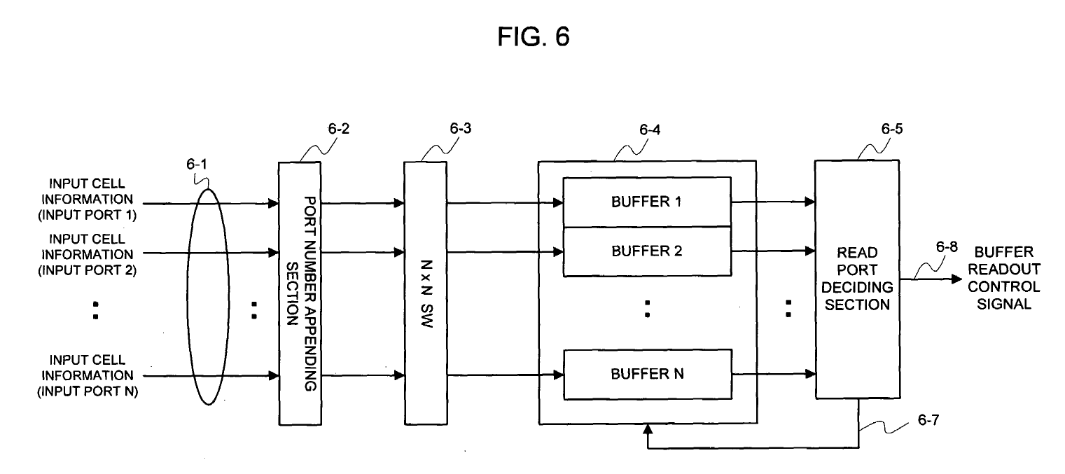

In FIG. 5, input signals 5-4-1-5-4-M toward readout control sections 5-6-1-5-6-M are the same as the input signals 1-3-1-1-3-M after filtering (i.e., comprising a fixed-length cell and input-cell information). The internal configuration of the readout control sections 5-6-1-5-6-M in the second embodiment is shown in FIG. 6.

Input-cell information 6-1 are input to a port number appending section 6-2. The port number appending section 6-2 generates a signal indicating the input port number for each piece of the input-cell information 6-1 that are supplied, and sends it along with the input-cell information to a subsequent N×N SW 6-3.

The N×N SW 6-3 performs switching processing such that only valid input-cell information and port number among those supplied from the ports toward buffers 1-N constituting a buffer 6-4 that serves as an output destination are evenly stored in a sequence of buffer 1-->buffer 2-->buffer 3-->buffer 4-->buffer 1--> . . .

The buffer 6-4 is comprised of N FIFO (First In First Out) memories of buffers 1-N, and is written with input-cell information and input port number whose input-cell information indicates valid.

A read port deciding section 6-5 reads information from the buffers 1-N on a piece-by-piece basis with reference to the buffer readout signal 6-7 if any piece of information is stored in the buffer 6-4, and sends a buffer readout control signal 6-6 to allow data of the input port whose input-cell information indicates valid among those read from the buffers 1-N to be sequentially read.

Readout schemes for the buffers 1-N that may be contemplated include one in which pieces of information in all buffers are simultaneously read in an N-cell time cycle, and one in which pieces of information are read sequentially across the buffers over an N-cell time.

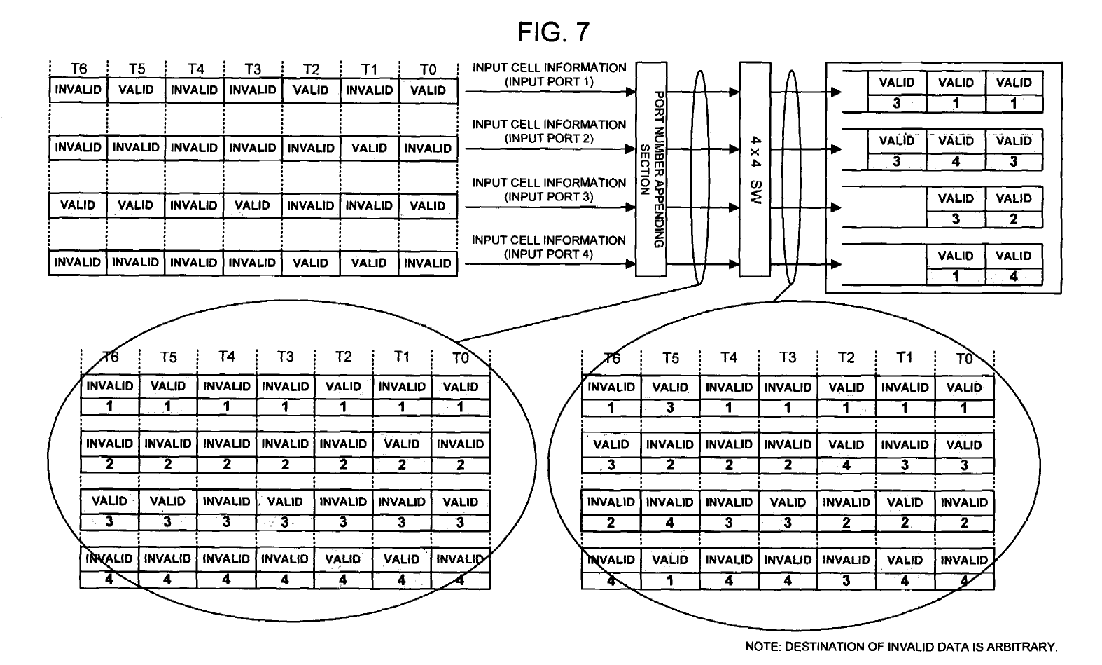

FIG. 7 is a block diagram schematically showing write processing for input-cell information into the buffers 1-N in the readout control section of FIG. 6. In this drawing, the number of ports to be accommodated N is assumed to be four.

Input-cell information (a signal indicating a fixed-length cell being input is valid or not) for a fixed-length cell being input is input in the sequence of time T0-->T1-->T2--> . . . -->T6. The port number appending section performs processing of appending a signal indicating a port number to input-cell information supplied from each port.

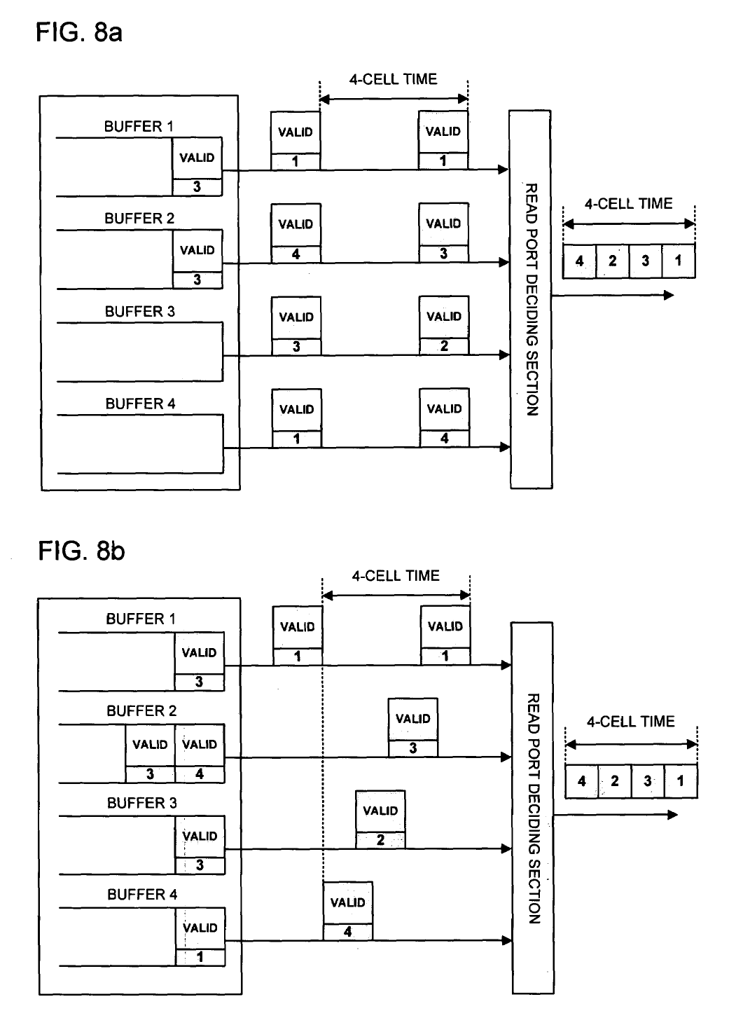

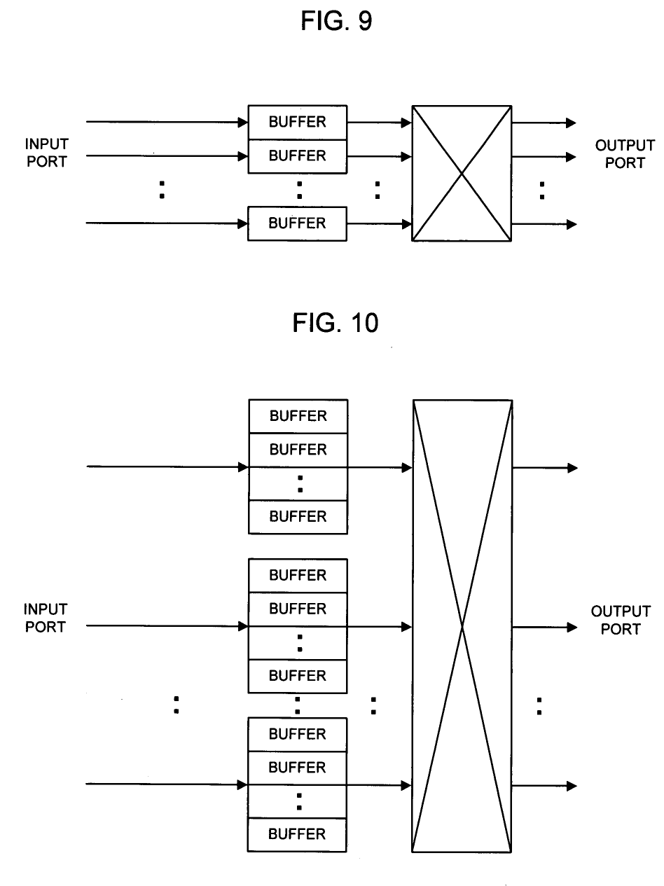

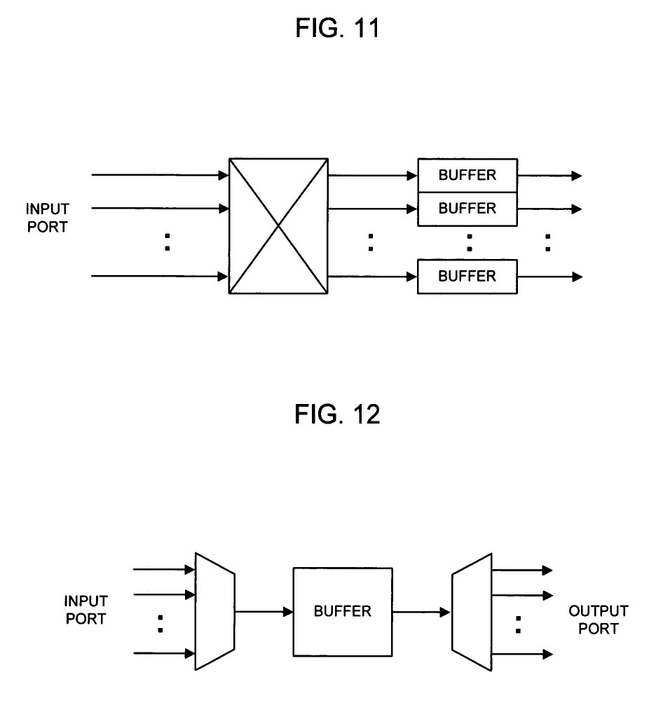

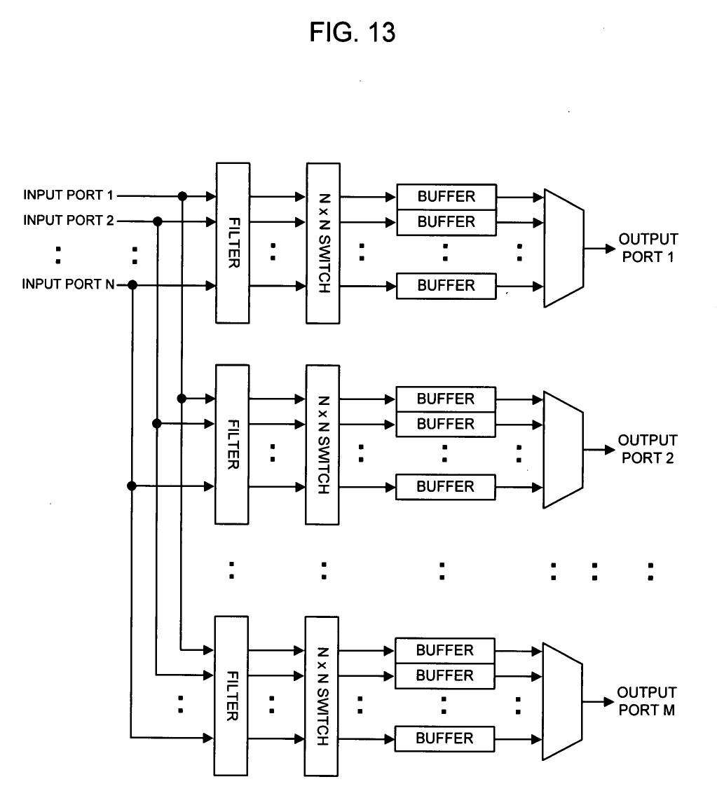

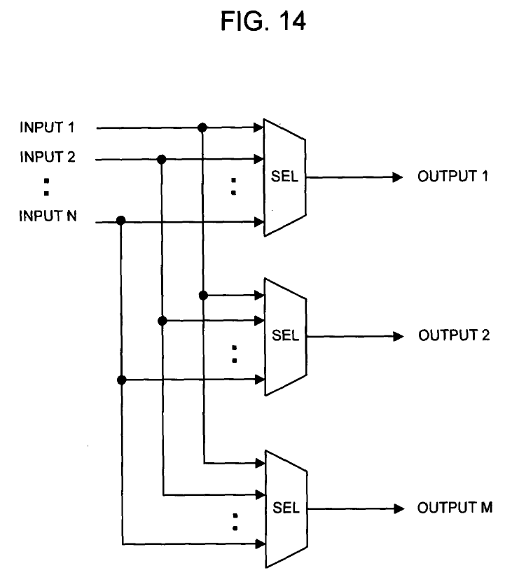

The N×N SW performs switching processing such that only valid input-cell information and port number among those supplied from the ports are evenly stored in a sequence of buffer 1-->buffer 2-->buffer 3-->buffer 4-->buffer 1--> . . . It should be noted that if such readout processing as shown in FIG. 8a is to be performed, a destination of writing should be reset to the buffer 1 after all the buffers have become empty.

FIGS. 8a and 8b are block diagrams schematically showing readout processing for input-cell information from the buffers 1-N in the readout control section of FIG. 6. In this drawing, the number of ports to be accommodated N is assumed to be four.

The input-cell information accumulated in the buffers as shown in FIGS. 8a and 8b are read in two methods, for example.

One method is to simultaneously read all buffers in a four-cell cycle as shown in FIG. 8a. In this scheme, data in buffers 1-4 are simultaneously read, and control is made such that data is read from a port number whose input-cell information indicates valid among the read input-cell information and port numbers.

Another method is to read sequentially for the buffers as shown in FIG. 8b. In this scheme, data are read in a sequence of buffer 1-->buffer 2-->buffer 3-->buffer 4-->buffer 1--> . . . , and control is made such that data is read from a port number whose input-cell information indicates valid among the read input-cell information and port numbers. In this scheme, readout should be suspended while a buffer to be read is empty, and resumed when data is accumulated in that buffer.

The entire disclosure of Japanese Patent Application No. 2006-086709 filed on Mar. 27, 2006 including specification, claims, drawing and summary are incorporated herein by reference in its entirety.

What is claimed is:

1. A cell switch having input ports and output ports, comprising:
filters for outputting cells input from said input ports, and cell information indicating whether each cell is valid or not, for each of said output ports, which becomes a destination of each of said cells;
cell buffers for holding valid cells among said cells output for each of said output ports, for each of said input ports and in the sequence of inputting; and
a readout controller for reading said cells from said buffers based on said cell information.

2. A cell switch according to claim 1, wherein said readout controller includes:
cell information buffers for holding cell information output for each of said output ports, for each of said input ports and in the sequence of inputting; and
a deciding section for simultaneously reading cell information from said cell information buffers, and reading a cell kept in said cell buffer corresponding to identification information that uniquely identifies an input port whose cell information is valid.

3. A cell switch according to claim 1, wherein said readout controller includes:
an appending section for appending, to said cell information, identification information that uniquely identifies an input port to which said cell information has been input;
a switching section for outputting cell information that is valid among those appended with said identification information, evenly to said cell information buffers; and
a deciding section for reading cell information from said cell information buffer, and reading a cell kept in said cell buffer corresponding to identification information appended to said cell information.

4. A cell switch according to claim 3, wherein said deciding section simultaneously reads said cell information from said cell information buffers.

5. A cell switch according to claim 3, wherein said deciding section sequentially reads said cell information from said cell information buffers.

6. A readout method for a cell switch having input ports and output ports, comprising the steps of:
outputting cells input from said input ports, and cell information indicating whether each cell is valid or not, for each of said output ports, which becomes a destination of each of said cells; and
reading-out, based on said cell information, cells from cell buffers for holding valid cells among said cells output for each of said output ports, for each of said input ports and in the sequence of inputting.

7. A readout method according to claim 6, wherein said reading-out step includes the steps of:
simultaneously reading cell information from cell information buffers for holding cell information output for each of said output ports, for each of said input ports and in the sequence of inputting; and
reading a cell kept in said cell buffer corresponding to identification information that uniquely identifies an input port whose cell information read is valid.

8. A readout method according to claim 6, wherein said reading-out step includes the steps of:
appending, to said cell information, identification information that uniquely identifies an input port to which said cell information has been input;
outputting cell information that is valid among those appended with said identification information, evenly to said cell information buffers; and
reading-out cell information from said cell information buffer, and reading-out a cell kept in said cell buffer corresponding to identification information appended to said cell information.

9. A readout method according to claim 8, wherein said reading-out step simultaneously reads said cell information from said cell information buffers.

10. A readout method according to claim 8, wherein said reading-out step sequentially reads said cell information from said cell information buffers.
